(19) United States
(12) Patent Application Publication
(10) Pub. No.: US 2005/0160729 A1
(43) Pub. Date: Jul. 28, 2005

(54) Rotating fluid machine

(75) Inventor: Haruhiko Komatsu, Wako-shi (JP)

Correspondence Address: BIRCH STEWART KOLASCH & BIRCH, PO BOX 747, FALLS CHURCH, VA, 22040-0747, US

(73) Assignee: HONDA MOTOR CO., LTD., Tokyo (JP)

(21) Appl. No.: 11/010,369

(22) Filed: Dec. 14, 2004

(30) Foreign Application Priority Data
Dec. 15, 2003 (JP) 2003-416233

(51) Int. Cl. F16D 39/00

(52) U.S. Cl. 60/487

(57) ABSTRACT

A piston of an axial piston cylinder group A of an expander is driven by a cam surface with a height that changes in a direction of an axis L of a rotor formed on a cam member fixed to a casing to surround the axis L. A roller rotatably provided at a tip end of the piston abuts against the cam surface. Therefore, timing and length of each intake stroke, expansion stroke and exhaust stroke are optionally set, and the piston is driven in an optional timing and at an optional speed, to enhance the efficiency of the expander. The roller rolls on the cam surface to minimize transmission, from the cam surface to the piston, of the reaction force which does not contribute to torque of the rotor, and to prevent the sliding surfaces of the piston and the cylinder sleeve from twisting to enhance durability.

### CROSS-REFERENCE TO RELATED APPLICATIONS

This nonprovisional application claims priority under 35 U.S.C. § 119(a) on Patent Application No. 2003-416233, filed in Japan on Dec. 15, 2003, the entirety of which is incorporated herein by reference.

### BACKGROUND OF THE INVENTION

1. Field of the Invention

The present invention relates to a rotating fluid machine including a casing, a rotor rotatably supported in the casing, and an axial piston cylinder group disposed at the rotor to surround an axis of the rotor.

2. Description of the Related Art

A rotating fluid machine is disclosed in Japanese Patent Application Laid-open No. 2002-256805. This rotating fluid machine includes a first axial piston cylinder group disposed in an inner side in the radial direction, and a second axial piston cylinder group disposed in an outer side in the radial direction. A tip end of a piston of the first axial piston cylinder group abuts to a dimple of a swash plate, and a piton of the second axial piston cylinder group is connected to the swash plate via a connecting rod.

When the stroke of the piston of the axial piston cylinder group of the expander is controlled by the swash plate, the stroke of the piston with respect to the rotational angle of the rotor is disadvantageously restricted to a sinewave shape. Therefore, increasing the expansion ratio by enlarging the length of the expansion stroke to exceed 180° of the rotational angle of the rotor is impossible, because the maximum length of the expansion stroke is limited to 180° by the swash plate.

### SUMMARY OF THE INVENTION

The present invention has been achieved in view of the above circumstances, and has an object to optionally set the relationship of the stroke of a piston with respect to a rotational angle of a rotor of a rotating fluid machine.

In order to attain the above-described object, according to a first feature of the present invention, there is provided a rotating fluid machine including a casing; a rotor which is rotatably supported in the casing. An axial piston cylinder group is disposed at the rotor to surround an axis of the rotor. An annular cam member is fixed to the casing to surround the axis, and is provided with a cam surface whose height changes in a direction of the axis. A cam follower is provided at a tip end of a piston of the axial piston cylinder group, and abuts to the cam surface of the cam member.

According to a second feature of the present invention, in addition to the first feature, the cam follower is a roller having a rotary shaft extending in a radial direction with the axis as a center.

According to a third feature of the present invention, in addition to the second feature, the rotating fluid machine further includes a rotation preventing device which prevents the piston from rotating with respect to the cylinder sleeve.

A ball 56, a roller 76 and a roller pin 77 in embodiments correspond to the rotation preventing device of the present invention. A roller 73 in the embodiments corresponds to the cam follower of the present invention.

With the arrangement of the first feature, in order to guide the piston of the axial piston cylinder group of the rotating fluid machine, the cam surface whose height changes in the direction of the axis of the rotor is formed on the annular cam member fixed to the casing to surround the axis. In addition, the cam follower is provided at the tip end of the piston and is made to abut against the cam surface. Therefore, the timing and the length of each of the strokes such as an intake stroke, an expansion stroke and an exhaust stroke are optionally set, and the piston is operated in an optional timing and at an optional speed, to thereby enhance the efficiency of the expander.

With the arrangement of the second feature, the cam follower is provided at the piston and abuts to the cam surface of the cam member and is constructed by the roller having the rotary shaft extending in the radial direction with the axis of the rotor as the center. Therefore, the reaction force acting from the cam surface on the piston is made to act only in the tangential direction of the rotor, so that twisting of the piston and an increase in the slide resistance can be minimized. In addition, the contact between the cam follower and the cam surface is not a sliding contact but a rolling contact, whereby the abrasion of the cam follower and the cam surface is suppressed to enhance durability.

With the arrangement of the third feature, the piston is prevented from rotating with respect to the cylinder sleeve by the rotation preventing device. Therefore, the direction of the rotary shaft of the cam follower is always made to correspond to the radial direction with respect to the axis line, so that the reaction force acting from the cam surface on the piston can be made to act only in the tangential direction of the rotor.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a longitudinal sectional view of an expander;

FIG. 2 is a sectional view taken along the 2-2 line in FIG. 1;

FIG. 3 is a view seen along the line 3-3 in FIG. 1;

FIG. 4 is an enlarged view of the section 4 in FIG. 1;

FIG. 5 is an exploded perspective view of a rotor;

FIG. 6 is a sectional view taken along the line 6-6 in FIG. 4;

FIG. 7 is a sectional view taken along the line 7-7 in FIG. 4;

FIG. 8 is a view seen along the line 8-8 in FIG. 4;

FIG. 9 is a perspective view showing the relationship between a cam member and a piston;

FIG. 10 is a graph showing the relationship between the rotational angle of the rotor and the stroke of the piston;

FIGS. 11A and 11B are views showing the relationship between the rotational angle of the rotor and each stroke;

FIG. 12 is a view corresponding to FIG. 4, according to a second embodiment of the present invention;

FIG. 13 is a sectional view taken along the line 13-13 in FIG. 12;

FIG. 14 is a view seen along the line 14-14 in FIG. 12;

FIG. 15 is a view corresponding to FIG. 4, according to a third embodiment of the present invention;

FIG. 16 is a sectional view taken along the line 16-16 in FIG. 15; and

FIG. 17 is a view taken along the line 17-17 in FIG. 15.

### DESCRIPTION OF THE PREFERRED EMBODIMENT

An expander E of this embodiment is used in, for example, a Rankine cycle system. The expander E converts the thermal energy and the pressure energy of high-temperature high-pressure steam as a working medium into mechanical energy, and outputs it. A casing 11 of the expander E is formed from a casing body 12 with a front cover 15 joined via a seal 13 to a front opening of the casing body 12 by a plurality of bolts 14. A rear cover 18 is joined via a seal 16 to a rear opening of the casing body 12 by a plurality of bolts 17. An oil pan 21 is joined via a seal 19 to a lower opening of the casing body 12 by a plurality of bolts 20.

A rotor 22 is arranged rotatably around an axis L extending in the fore-and-aft direction through the center of the casing 11 and includes a front part supported by combined angular bearings 23 provided in the front cover 15 with a rear part thereof supported by a radial bearing 24 provided in the casing body 12. A cylindrical cam member 25 is fixed to a rear surface of the front cover 15 to surround an axis L by a plurality of bolts 26. An endless cam surface 25a with a height that changes in the direction of the axis L is formed on a rear end surface of the cam member 25.

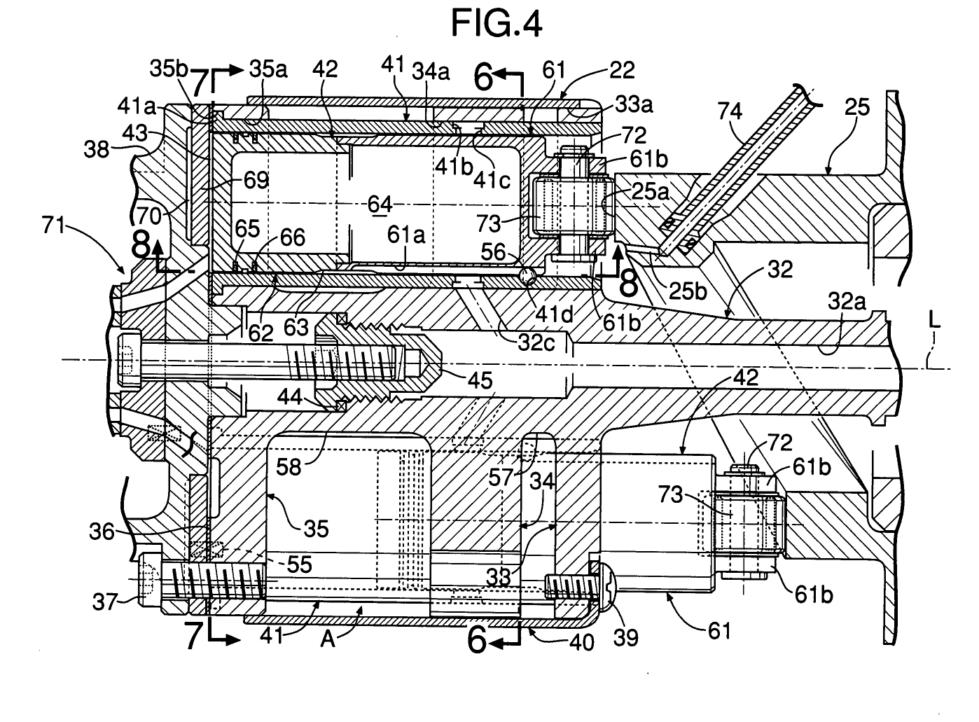

The rotor 22 includes an output shaft 32 supported in the front cover 15 by the combined angular bearings 23. Three sleeve support flanges 33, 34, and 35 are formed integrally with a rear part of the output shaft 32 via notches 57 and 58 (see FIG. 4) of predetermined widths from one another. A rotor head 38 is joined by a plurality of bolts 37 to the rear sleeve support flange 35 via a metal gasket 36 and is supported in the casing body 12 by the radial bearing 24. A heat-insulating cover 40 is fitted over the three sleeve support flanges 33, 34, and 35 from the front and is joined to the front sleeve support flange 33 by a plurality of bolts 39.

Sets of five sleeve support holes 33a, 34a, and 35a are formed in the three sleeve support flanges 33, 34, and 35, respectively, at intervals of 72° around the axis L. Five cylinder sleeves 41 are fitted into the sleeve support holes 33a, 34a, and 35a from the rear. A flange 41a is formed on the rear end of each of the cylinder sleeves 41, and axial positioning is carried out by abutting the flange 41a against the metal gasket 36 while fitting the flange 41a into a step 35b formed in the sleeve support holes 35a of the rear sleeve support flange 35 (see FIG. 4). A piston 42 is slidably fitted within each of the cylinder sleeves 41 with a steam expansion chamber 43 being defined between the rear end of the piston 42 and the rotor head 38.

A plate-shaped bearing holder 92 is overlaid on a front surface of the front cover 15 via a seal member 91 and is fixed by bolts 93. A pump body 95 is overlaid on a front surface of the bearing holder 92 via a seal member 94 and is fixed by bolts 96. The combined angular bearings 23 and 23 are sandwiched between the step portion of the front cover 15 and the bearing holder 92 and fixed in the direction of the axis L.

A shim 97 of a predetermined thickness is held between a flange 32d formed at the output shaft 32 which supports the combined angular bearings 23 and 23, and an inner race of the combined angular bearings 23 and 23. The inner race of the combined angular bearings 23 and 23 is fastened by a nut 98 screwed into an outer periphery of the output shaft 32. As a result, the output shaft 32 is positioned in the direction of the axis L with respect to the combined angular bearings 23 and 23, namely, the casing 11.

An oil passage 32a extending on the axis L is formed inside the output shaft 32 integral with the rotor 22. A front end of the oil passage 32a branches in the radial direction and communicates with an annular groove 32b at an outer periphery of the output shaft 32. At an inside position in the radial direction of the sleeve supporting flange 34 at the center of the rotor 22, an oil passage blocking member 45 is screwed into an inner periphery of the oil passage 32a via a seal member 44. A plurality of oil holes 32c extend in the radially outward direction from the oil passage 32a in the vicinity of the oil passage blocking member 45 and open to an outer peripheral surface of the output shaft 32.

A trochoid oil pump 49 is disposed between a recessed portion 95a formed in a front surface of a pump body 95 and a pump cover 48 fixed to the front surface of the pump body 95 via a seal member 46 by a plurality of bolts 47. The trochoid oil pump 49 includes an outer rotor 50 rotatably fitted into the recessed portion 95a, and an inner rotor 51 fixed to the outer periphery of the output shaft 32 and meshed with the outer rotor 50. An internal space of the oil pan 21 communicates with an inlet port 53 of the oil pump 49 via an oil pipe 52 and an oil passage 95b of the pump body 95. A discharge port 54 of the oil pump 49 communicates with an annular groove 32b of the output shaft 32 via an oil passage 95c of the pump body 95.

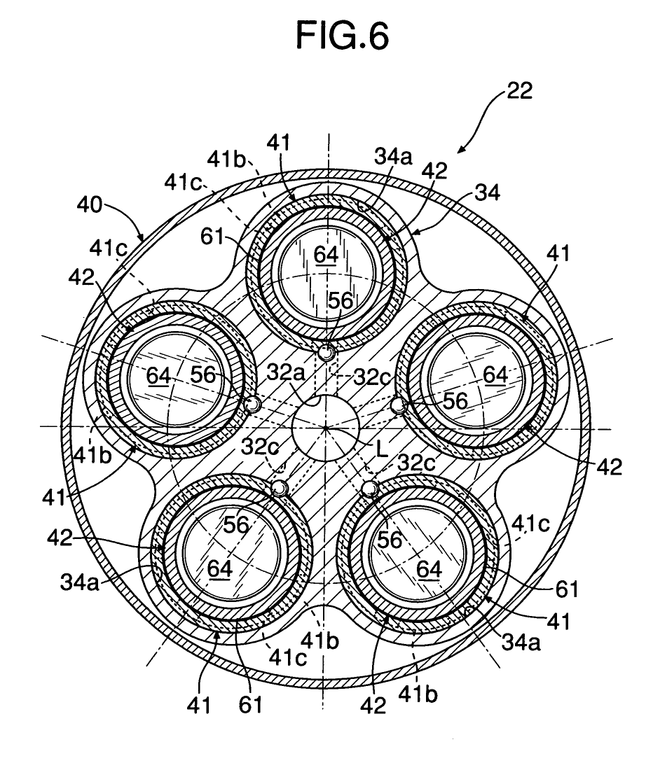

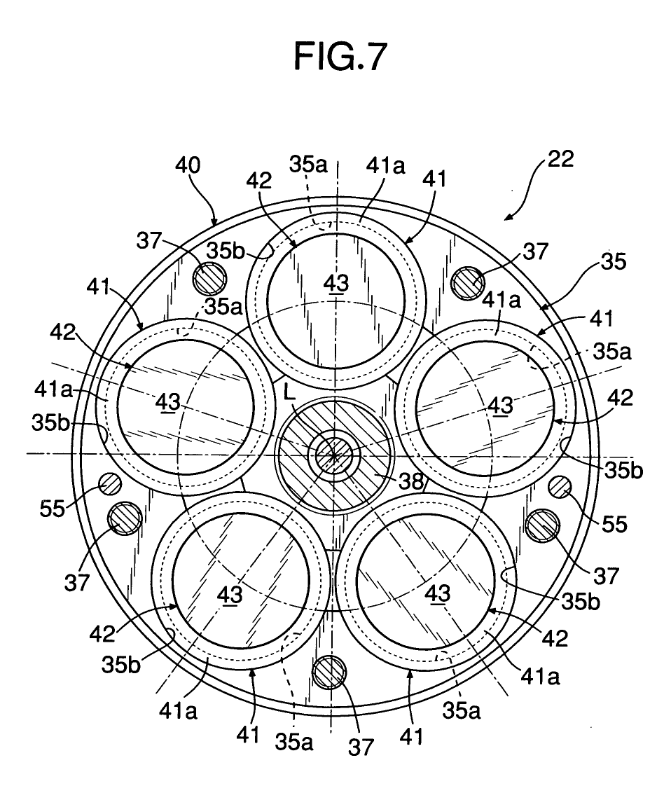

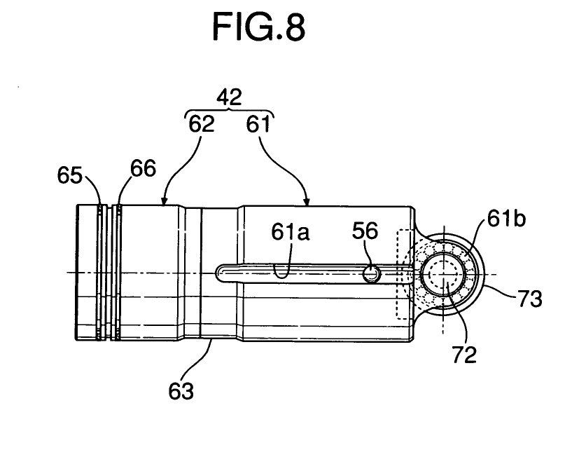

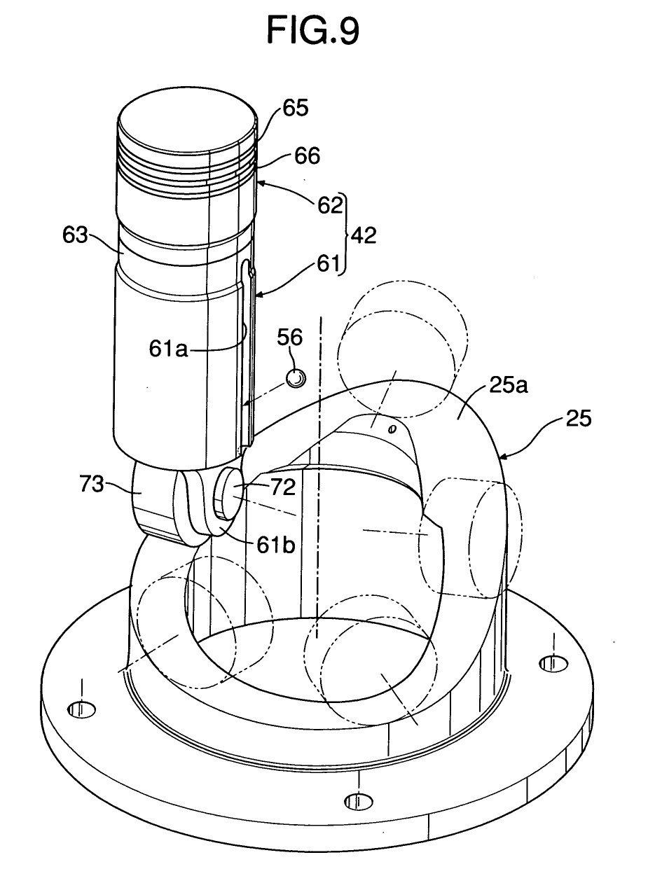

Next, the structure of the piston 42 will be described in detail with reference to FIG. 4 to FIG. 9.

The piston 42 is constructed by integrally connecting a tip end part 61 and a base end part 62 by welding. A large-volume and vacuum heat-insulating space 64 is defined inside the piston 42. A top ring 65 and a second ring 66 are supported at an end portion of the base end part 62 on the side of an expansion chamber 43. At a connecting portion of the tip end part 61 and the base end part 62, an annular oil groove 63 is formed which is slightly smaller in diameter. A ball guide groove 61a is formed that extends from the oil groove 63 in the direction of the axis L along an outer periphery of the tip end part 61. A semispherical ball supporting hole 41d is formed in an inner surface of the cylinder sleeve 41. A ball 56 is placed astride the ball supporting hole 41d and the ball guide groove 61a.

A roller 73 in a ball bearing shape is rotatably supported via a rotary shaft 72 between a pair of brackets 61b and 61b projecting forward from the tip end part 61 of the piston 41. The piston 41 is positioned in the rotational direction while being enabled to move in the direction of the axis L by the ball 56 engaged in the ball supporting hole 41d and the ball guide groove 61a. In this positioned state, the rotary shaft 72 of the roller 73 extends in the radial direction with respect to the axis L. The roller 73 rollably abuts against a cam surface 25a of the cam member 25. At this time, the roller 73 and the cam surface 25a are in linear contact with each other within a plane perpendicular to the axis L.

An oil supply pipe 74 leading to an oil supply source (not shown) is inserted into the cam member 25 in order to lubricate the cam surface 25a on which the roller 73 rolls. An oil supply hole 25b extends from the oil supply pipe 74 and opens to a position near the cam surface 25a.

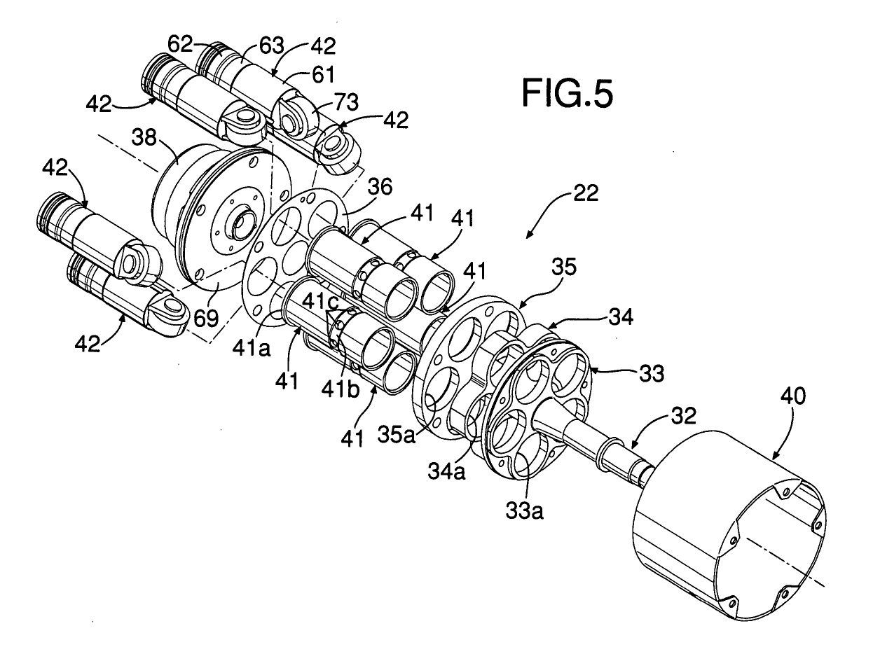

An annular groove 41b (see FIG. 4 and FIG. 5) is formed in an outer periphery of a middle portion of the cylinder sleeve 41. A plurality of oil holes 41c are formed in the annular groove 41b. The oil groove 63 formed in the piston 42 communicates with the oil holes 41c of the cylinder sleeve 41.

An annular lid member 69 is welded to a front side of a rotor head 38 connected to a rear surface of the sleeve supporting flange 33 at the front side of the rotor 22 by bolts 37, or is welded to the side of the expansion chamber 43. An annular heat insulating space 70 (see FIG. 4) is defined on a back or rear surface of the lid member 69. The rotor head 38 is positioned by a knock pin 55 in the rotational direction with respect to the sleeve supporting flange 35 at the rear.

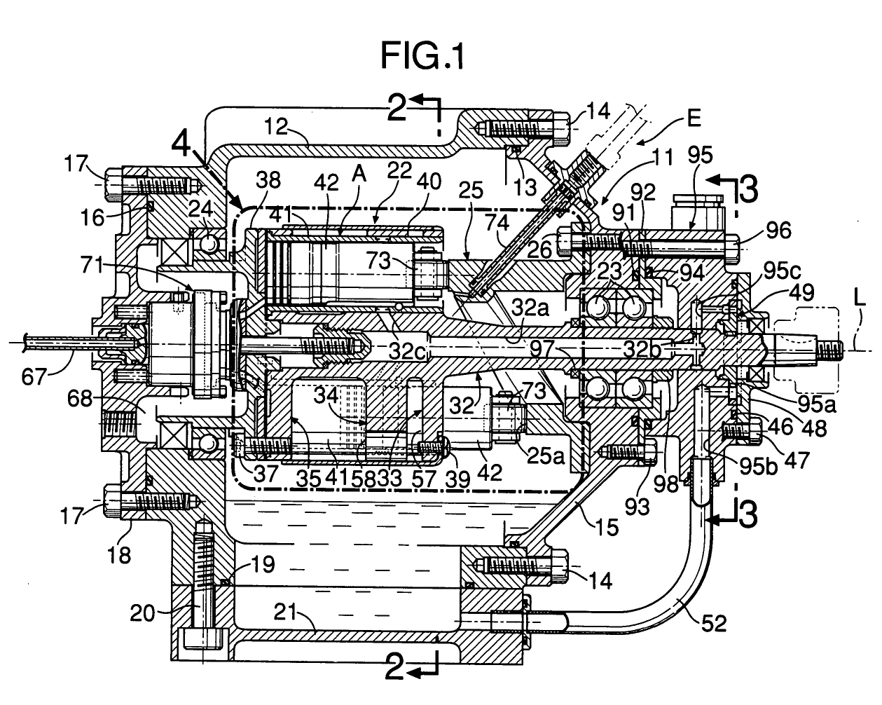

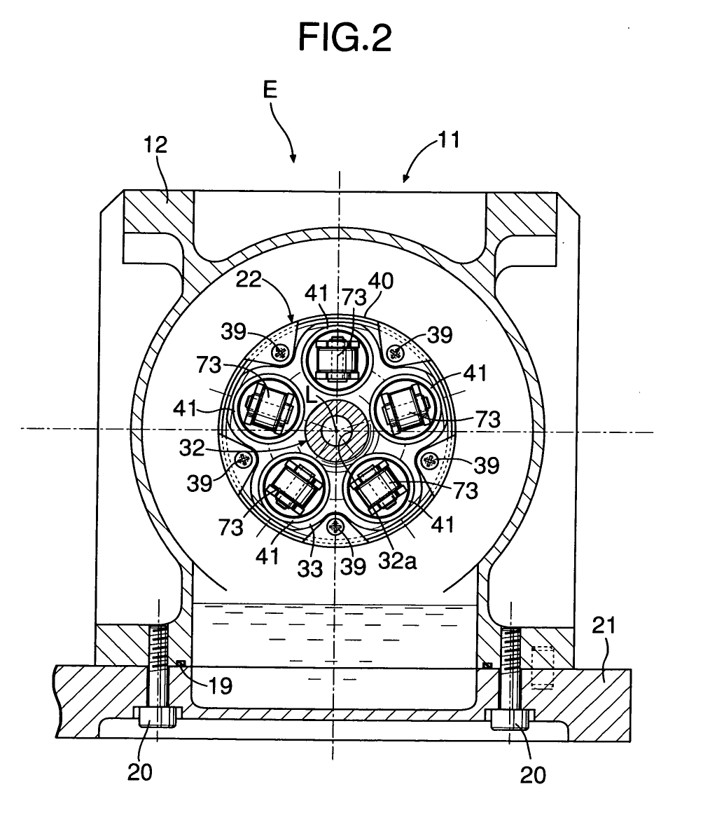

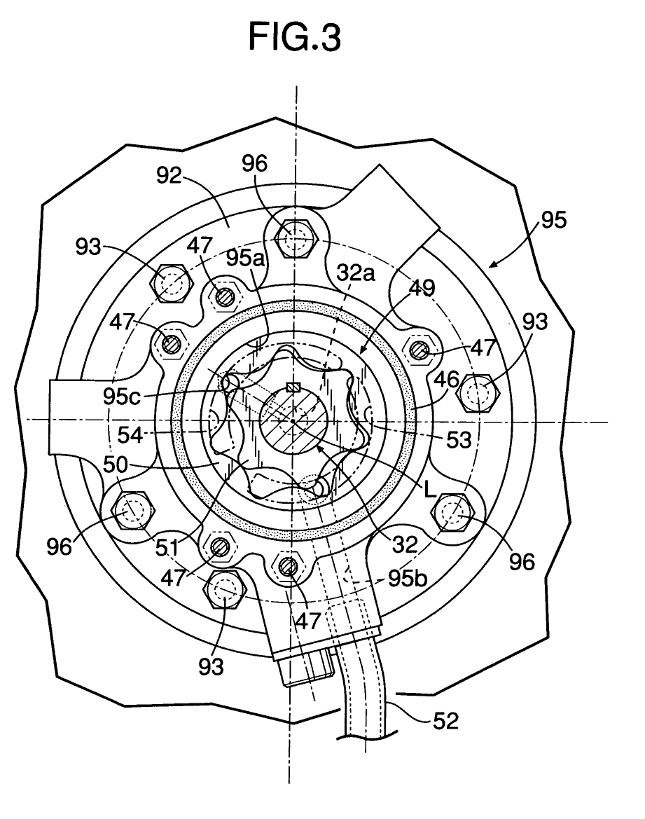

As shown in FIG. 1, a rotary valve 71 is provided between the rear cover 18 of the casing 11 and the cylinder head 38 of the rotor 22. The rotary valve 71 sequentially supplies the high-temperature high-pressure steam from a steam supply pipe 67 to the five expansion chambers 43 following the rotation of the rotor 22. The resultant low-temperature and low-pressure steam from the expansion chambers 43 is discharged into a steam discharge chamber 68 defined between the body casing 12 and the rear cover 18.

Five cylinder sleeves 41 and five pistons 42 constitute the axial piston cylinder group A of the present invention.

Next, an operation of the expander E of this embodiment having the above-described construction will be described.

When the high-temperature high-pressure steam generated by heating water with an evaporator is supplied from the steam supply pipe 67 via the rotary valve 71 into the expansion chamber 43 in the cylinder sleeve 41, the piston 42 fitted in the cylinder sleeve 41 is pushed out forward from the top dead center toward the bottom dead center, so that the roller 73 provided at the tip end part 61 of the piston 42 presses the cam surface 25a of the cam member 25. As a result, a rotational torque is given to the rotor 22 by the reaction force which the piston 42 receives from the cam surface 25a. Each time the rotor 22 makes one-fifth of a rotation, the high-temperature high-pressure steam is supplied into a new adjacent expansion chamber 43, to continuously drive the rotor 22 to rotate. While the piston 42, which has reached the bottom dead center following the rotation of the rotor 22, retreats toward the top dead center by being pressed by the cam surface 25a, the low-temperature low-pressure steam forced out of the expansion chamber 43 is discharged into the steam discharge chamber 68 via the rotary valve 71.

The oil pump 49 provided at the output shaft 32 is operated following the rotation of the rotor 22. Oil which is sucked from the oil pan 21 through the oil pipe 52, the oil passage 95b of the pump body 95 and the inlet port 53, is discharged from the discharge port 54. Oil is then supplied to the oil groove 63 formed in the outer peripheral surface of the piston 42 through the oil passage 95c of the pump body 95, the oil passage 32a of the output shaft 32, the annular groove 32b of the output shaft 32, the oil holes 32c of the output shaft 32, the annular groove 41b of the cylinder sleeve 41 and the oil holes 41c of the cylinder sleeve 41. The oil held in the oil groove 63 lubricates sliding surfaces of the piston 42 and the cylinder sleeve 41, and is thereafter returned to the oil pan 21.

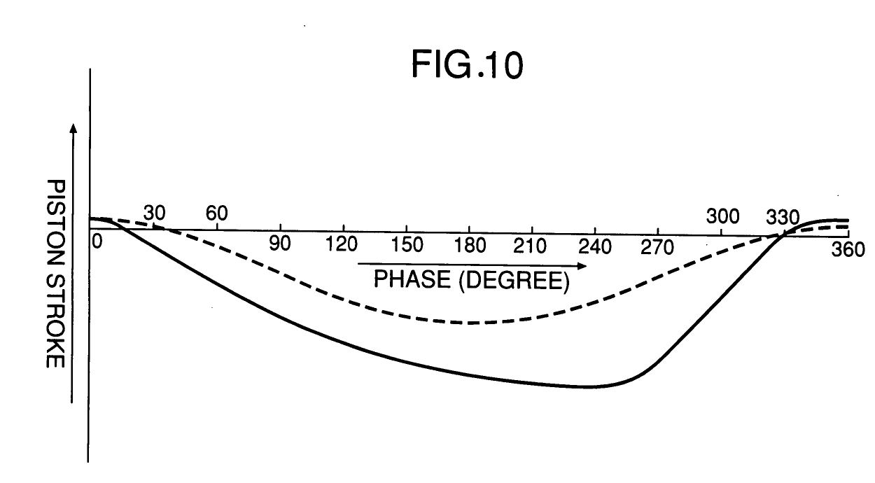

As shown by the broken line in FIG. 10, in the prior art in which the piston 42 of the axial piston cylinder group A is made to abut against the dimple of the swash plate, the stroke of the piston 42 with respect to the phase of the rotor 22 is determined to be a sinewave shape. However, this embodiment uses the cam member 25 in place of the swash plate, whereby the relationship of the stroke of the piston 42 with respect to the rotational angle of the rotor 22 can be optionally set as shown by the solid line in FIG. 10.

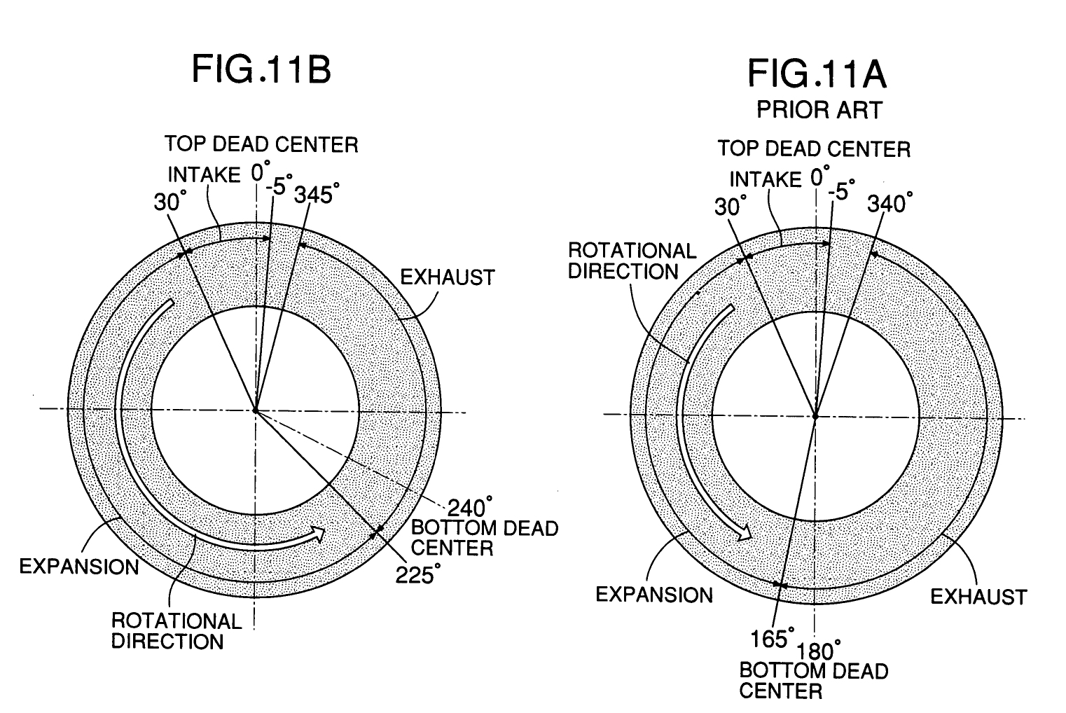

FIGS. 11A and 11B show the relationship of the rotational angle of the rotor 22, and the intake stroke, the expansion stroke and the exhaust stroke. In the prior art using the swash plate shown in FIG. 11A, the expansion stroke can be taken only up to the vicinity of the bottom dead center at the phase of 180°. However, in this embodiment using the cam member 25 as shown in FIG. 11B, it is possible to take as long an expansion stroke as up to the vicinity of the bottom dead center of the phase of 240°. Therefore, the expansion ratio of the high-temperature high-pressure steam is increased to increase the output force of the expander E.

In the prior art in which the tip end portion of the piston 42 is made to abut against the dimple of the swash plate, the abutting point between the piston 42 and the dimple of the swash plate moves following the rotation of the rotor 22. Therefore, the reaction force which the piston 42 receives from the swash plate obtains components other than the component in the direction to causes the rotor 22 to generate effective torque (namely, the tangential direction of the rotor 22), causing a problem of twisting of the piston 42 and an increase in the slide resistance due to such unnecessary reaction force components.

In contrast, in this embodiment, the roller 73 provided at the tip end of the piston 42 is made to rollably abut against the cam surface 25a of the cam member 25, and the piston 42 is prevented from rotating by the ball 56 to make the roller 73 and the cam surface 25a to be always in linear contact with each other on the radial line with the axis L as the center. Therefore, the reaction forces other than that in the tangential direction of the rotor 22 are prevented from acting on the piston 42, so that the twisting of the piston 42 and the increase in the slide resistance are minimized, to thereby enhance output force and durability of the expander E.

In the prior art, there is a limitation when the inclination angle of the swash plate is increased in order to secure a large expansion ratio of the expander E by increasing the stroke of the piston 42. However, if the piston 42 is disposed on a large pitch circle to enlarge the stroke without increasing the inclination angle of the swash plate, there is also a problem that the dimensions of the expander E are increased. However, according to this embodiment, the cam member 25 is used in place of the swash plate. Thus, the stroke of the piston 42 can be easily enlarged, thereby securing a large expansion ratio to enhance the output force without enlarging the expander E.

The ball 56 is engaged in the ball guide groove 61a formed in the outer peripheral surface of the piston and in the ball supporting hole 41d formed in the inner peripheral surface of the cylinder sleeve 41. Therefore, the piston 42 can be reliably prevented from rotating with a simple structure involving small numbers of components and machining steps.

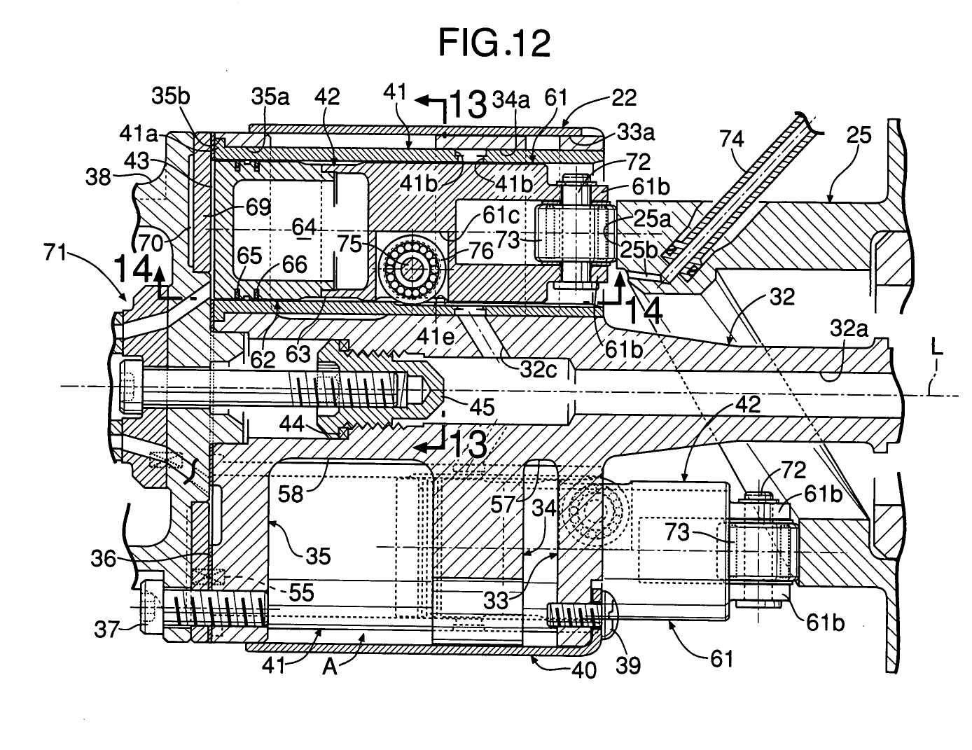

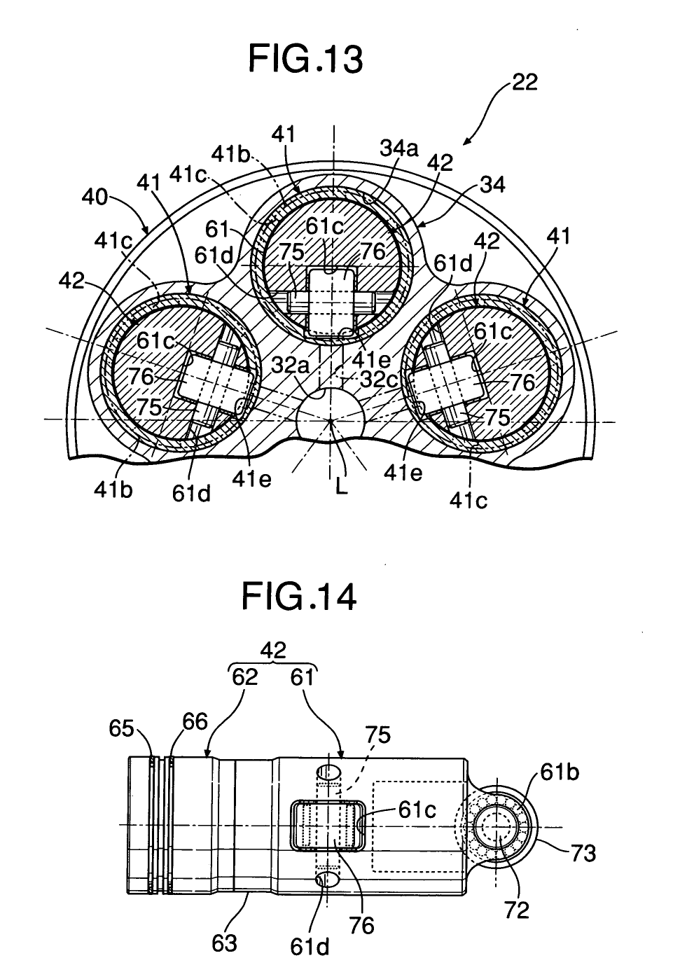

FIG. 12 to FIG. 14 show a second embodiment of rotation preventing structure for the piston 42.

In the second embodiment, the piston 42 includes a recessed portion 61c which opens to one side surface of the tip end part 61. A roller 76 having a ball bearing shape is rotatably supported at a rotary shaft 75 which is inserted into a shaft hole 61d penetrating through the recessed portion 61c. An outer peripheral surface of the roller 76 slightly protrudes in the radially outward direction from the outer peripheral surface of the piston 42, and rollably abuts against a flat guide groove 41e which is formed on the inner peripheral surface of the cylinder sleeve 41 in the direction of the axis line L.

As described above, the roller 76 and the guide groove 41e are in linear contact with each other in the tangential direction of the rotor 22, and therefore the piston 42 can be prevented from rotating while the piston 42 is enabled to slide smoothly in the direction of the axis L. According to the second embodiment, the Hertzian surface pressure, which the guide groove 41e of the cylinder sleeve 41 receives from the roller 76, can be made significantly small as compared with the Hertzian surface pressure which the ball guide groove 61a of the piston 42 of the first embodiment receives from the ball 56.

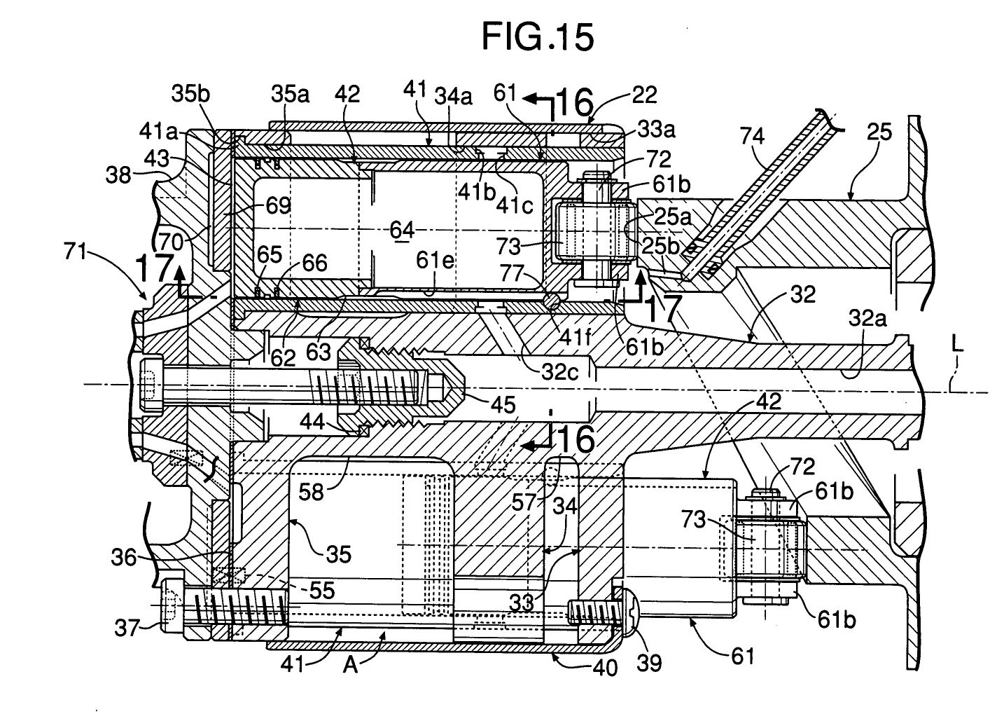

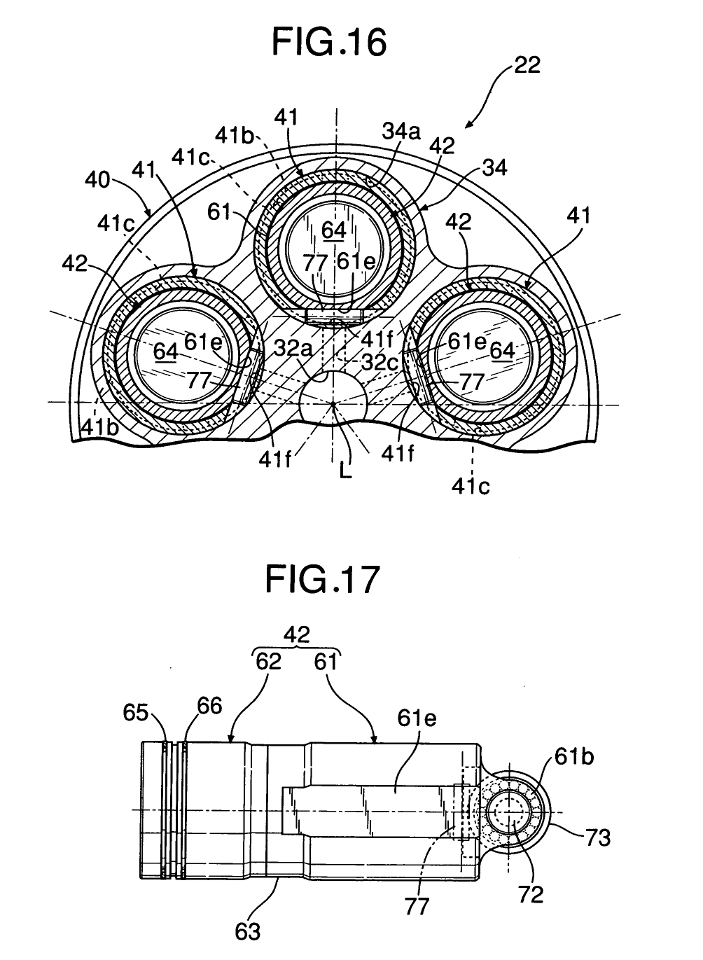

FIG. 15 to FIG. 17 show a third embodiment of rotation preventing structure of the piston 42.

The third embodiment includes a roller pin 77 rotatably inserted into a pin hole 41f which penetrates through the cylinder sleeve 41. A flat guide surface 61e that abuts against the roller pin 77 rollably is formed in the direction of the axis L on the outer peripheral surface of the tip end part 61 of the piston 42.

As described above, the roller pin 77 and the guide surface 61e are in linear contact with each other in the tangential direction of the rotor 22. Therefore, the piston 42 can be prevented from rotating while the piton 42 is enabled to slide smoothly in the direction of the axis L. According to the third embodiment, although the third embodiment has a simple structure as in the first embodiment, the Hertzian surface pressure of the guide portion can be reduced as compared with the first embodiment.

The embodiments of the present invention have been described, however various changes in design may be made without departing from the subject matter of the present invention.

The profile of the cam surface 25a of the cam member 25 is not limited to the embodiments as described, and may be appropriately changed in accordance with its purpose so that, for example, the expansion stroke is performed at an early stage after the intake stroke to recover energy before thermal loss and mechanical loss become large. The exhaust may suddenly be performed when the tension of the top ring 65 and the second ring 66 become weak upon opening of the exhaust port to reduce the exhaust pumping loss and mechanical loss. The exhaust port may be closed after the piton reaches the top dead center by reducing the stroke in the vicinity of the top dead center of the piston 42 to compress the liquefied working medium and suppress the occurrence of minus torque.

The cam follower is not limited to the roller 73 in the embodiments, and may be a ball rotatable in any direction. If such a ball is used, the prevention of rotation for the piston 42 is unnecessary. Also, it is possible to use a slider having abrasion resistance as a cam follower in place of a roller or ball. When the slider is used, the contact with the cam surface is not rolling contact, but sliding contact.

The rotating fluid machine of the present invention is not limited to the expander E, and is applicable to a compressor.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A rotating fluid machine comprising:
a casing;
a rotor rotatably supported in the casing;
an axial piston cylinder group A being disposed at the rotor to surround an axis L of the rotor;
an annular cam member being fixed to the casing to surround the axis L, and provided with a cam surface having a height that changes in a direction of the axis L; and
a cam follower provided at a tip end of a piston of the axial piston cylinder group A, and abutting against the cam surface of the cam member.

2. The rotating fluid machine according to claim 1, wherein the cam follower is a roller having a rotary shaft extending in a radial direction with the axis L as a center.

3. The rotating fluid machine according to claim 2, and further comprising a rotation preventing device for preventing the piston from rotating with respect to a cylinder sleeve.

4. The rotating fluid machine according to claim 1, and further including a bracket positioned on the tip end of the piston and said cam follower being operatively mounted relative to said bracket.

5. The rotating fluid machine according to claim 4, wherein said cam follower is a roller having a rotary shaft mounted relative to said bracket.

6. The rotating fluid machine according to claim 1, wherein said axial piston cylinder group include a plurality of individual pistons each being sequentially subjected to an expansion stroke, said expansion stroke may be as long an expansion stroke as up to the vicinity of a bottom dead center of a phase of 240 degrees.

7. The rotating fluid machine according to claim 6, wherein a ratio of a high-temperature high-pressure steam is increased to increase an output force of the rotating fluid machine.

8. The rotating fluid machine according to claim 3, wherein said rotation preventing device is ball engaged in a guide groove formed in an outer peripheral surface of the piston for preventing rotation of said piston within said cylinder sleeve.

9. The rotating fluid machine according to claim 3, wherein said piston includes a recess and the rotation preventing device is a roller mounted on a rotary shaft, said roller being engagable with a guide groove formed on an inner peripheral surface of the cylinder sleeve for preventing rotation of said piston.

10. The rotating fluid machine according to claim 1, wherein said rotation preventing device is pin mounted relative to a flat surface formed in an outer peripheral surface of the piston for preventing rotation of said piston within said cylinder sleeve.

11. A rotating fluid machine comprising:
a casing;
a rotor rotatably supported in the casing;
a plurality of axially arranged pistons mounted within cylindrical sleeves and being disposed at the rotor to surround an axis L of the rotor;
an annular cam member being fixed to the casing to surround the axis L, and provided with a cam surface having a height that changes in a direction of the axis L; and
a cam follower provided at a tip end of each of said plurality of pistons and abutting against the cam surface of the cam member for selectively permitting expansion, intake and exhaust cycles to occur for each piston.

12. The rotating fluid machine according to claim 11, wherein the cam follower is a roller having a rotary shaft extending in a radial direction with the axis L as a center.

13. The rotating fluid machine according to claim 12, and further comprising a rotation preventing device for preventing the piston from rotating with respect to a cylinder sleeve.

14. The rotating fluid machine according to claim 11, and further including a bracket positioned on the tip end of each of said plurality of pistons and said cam follower being operatively mounted relative to said bracket.

15. The rotating fluid machine according to claim 14, wherein said cam follower is a roller having a rotary shaft mounted relative to said bracket.

16. The rotating fluid machine according to claim 11, wherein each of said plurality of pistons are sequentially subjected to an expansion stroke, said expansion stroke may be as long an expansion stroke as up to the vicinity of a bottom dead center of a phase of 240 degrees.

17. The rotating fluid machine according to claim 16, wherein a ratio of a high-temperature high-pressure steam is increased to increase an output force of the rotating fluid machine.

18. The rotating fluid machine according to claim 13, wherein said rotation preventing device is ball engaged in a guide groove formed in an outer peripheral surface of each of said plurality of pistons for preventing rotation of said pistons within a respective cylinder sleeve.

19. The rotating fluid machine according to claim 13, wherein each of said plurality of pistons includes a recess and the rotation preventing device is a roller mounted on a rotary shaft, said roller being engagable with a guide groove formed on an inner peripheral surface of the cylinder sleeve for preventing rotation of each of said plurality of pistons.

20. The rotating fluid machine according to claim 11, wherein said rotation preventing device is pin mounted relative to a flat surface formed in an outer peripheral surface of each of said plurality of pistons for preventing rotation of each of said plurality of pistons within a respective cylinder sleeve.
